(19) United States
(12) Patent Application Publication
(10) Pub. No.: US 2011/0012989 A1
(43) Pub. Date: Jan. 20, 2011

(54) GUIDING METHOD FOR PHOTOGRAPHING PANORAMA IMAGE

(75) Inventors: Chia Chun Tseng, Hsinchu City (TW); Chien Hung Chen, Changhua County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Altek Corporation, Hsinchu (TW)

(21) Appl. No.: 12/565,326

(22) Filed: Sep. 23, 2009

(30) Foreign Application Priority Data
Jul. 17, 2009 (TW) 098124336

(51) Int. Cl. H04N 7/00

(52) U.S. Cl. 348/36; 348/E07.001

(57) ABSTRACT

A guiding method for photographing a panorama image is described. A motion vector between a current position of an alignment image in a real-time image and a joint position of the alignment image in the real-time image, and a direction indicator relative to the motion vector is displayed, such that when the digital camera device displays the real-time image, the digital camera device may display the direction indicator to guide a photographing position of a next image for a user, thereby simplifying the photographing of a panorama image and greatly decreasing an incidence that the user fails to photographing a panorama image.

### CROSS-REFERENCE TO RELATED APPLICATIONS

This non-provisional application claims priority under 35 U.S.C. §119(a) on Patent Application No(s). 098124336 filed in Taiwan, R.O.C. on Jul. 17, 2009, the entire contents of which are hereby incorporated by reference.

### BACKGROUND

1. Field of Invention

The present invention relates to a photographing method of a digital camera device, and more particularly, to a guiding method for photographing a panorama image.

2. Related Art

A panorama image aims to present a wide view, thus simulating scenery experience at about 160 degrees as can be seen by human eyes. An image of a common size is an area cut from the scenery. In comparison, a common image is more like an area to which human eyes pay attention, and a panorama image preferably enables a viewer to experience the environment at that time. The manner of making a panorama image is capturing a plurality of continuous images of the same size in a same scene, and joining the images together. Therefore, the joint area between the images to be joined is a key factor for whether the panorama image is able to be made or not.

Two conventional methods for photographing a panorama image exist now. In one method, user has to move a digital camera device to photograph a plurality of images manually (with hands or through tripods), input the photographed images in a computer then, and joining images through an image processing software to generate a panorama image. Such a manner is quite difficult for ordinary users. On one hand, the user needs professional photographing techniques; otherwise, subsequent image joining may become more difficult or effects are undesirable. On the other hand, the user also needs capability of operating complicated image software to join images.

In the other method, an assistant alignment image is displayed on a display screen of a digital camera device, for assisting a user to photograph and make a panorama image. However, in such a method, the user needs to superpose an alignment image and a real-time image to capture a plurality of continuous images. This process challenges the alignment capability of a user. The selected image might not be at a best alignment position due to errors made by human eyes, so the generated alignment error also influences a result of subsequent panorama joining Even though the user superposes the alignment image and the real-time image perfectly, when photographing, the digital camera device may still be shaken due to an action of pushing a shutter, thus causing the failure of the alignment at the instant of photographing, and the failure of the photographing of a panorama image.

### SUMMARY

Accordingly, the present invention is a guiding method for photographing a panorama image, thereby solving the problems of difficulties or failures in photographing a panorama image in the prior art.

The present invention provides a guiding method for photographing a panorama image, which is applied in a digital camera device. The digital camera device has a camera module and a display screen.

The guiding method for photographing a panorama image comprises the following steps. A first image is acquired by photographing scenery in front of the digital camera device with the camera module. The photographed first image is stored. After the first image is acquired, a real-time image is acquired by capturing the scenery in front of the digital camera device with the camera module. A motion vector between a current position of an alignment image in a real-time image and a joint position of the alignment image in the real-time image is calculated. The real-time image is displayed on the display screen, and a direction indicator having an indication direction and a size corresponding to the motion vector is displayed relative to the motion vector.

The alignment image is an image block having the same scenery as the first image in the real-time image. The joint position is a position where a second image to be photographed joins with the first image, and the scenery of the second image is the same as the scenery of the real-time image at the time of photographing to acquire the second image.

The digital camera device moves, and the real-time image changes accordingly. At the same time, the digital camera device acquires the real-time image, calculates a motion vector, and displays the real-time image and the direction indicator again, such that the direction indicator displayed on the display screen changes, for example, extends or contracts, with the real-time image.

Therefore, the user determines whether to photograph or not by observing the direction indicator, thus enabling the camera module to photograph the scenery in front of the digital camera device to acquire the second image.

In addition, the digital camera device may also automatically photograph the scenery in front of the digital camera device based on the calculated motion vector and a preset threshold value to acquire the second image.

Finally, the acquired first image and second image are joined to obtain a panorama image.

To sum up, the guiding method for photographing a panorama image according to the present invention is applied in the digital camera device. When a panorama image is being photographed, after one image is photographed, the digital camera device is able to output a suggesting signal, that is, a direction indicator (and a sound suggestion or vibration) to guide a position of photographing a next image for a user, thus simplifying the photographing of the panorama image and greatly decreasing an incidence that the user fails to photograph the panorama image.

### BRIEF DESCRIPTION OF THE DRAWINGS

The present invention will become more fully understood from the detailed description given herein below for illustration only, and thus are not limitative of the present invention, and wherein:

FIG. 1 is a flow chart of a guiding method for photographing a panorama image according to a first embodiment of the present invention;

FIG. 2A is a schematic view of a first image in a guiding method for photographing a panorama image according to an embodiment of the present invention;

FIG. 2B is a schematic view of a first image in a guiding method for photographing a panorama image according to an embodiment of the present invention;

FIG. 3 is a schematic view of a real-time image in a guiding method for photographing a panorama image according to an embodiment of the present invention;

FIG. 4 is a schematic view of the real-time image in FIG. 3 displayed on a display screen in a guiding method for photographing a panorama image according to the present invention;

FIGS. 5A and 5B are schematic views of a direction indicator in a guiding method for photographing a panorama image according to an embodiment of the present invention;

FIGS. 6A and 6B are schematic views of a direction indicator in a guiding method for photographing a panorama image according to another embodiment of the present invention;

FIG. 6C is a schematic view of a motion vector corresponding to the direction indicator in FIG. 6B in a guiding method for photographing a panorama image according to the present invention;

FIG. 7 is a flow chart of a guiding method for photographing a panorama image according to a second embodiment of the present invention;

FIG. 8 is a flow chart of a guiding method for photographing a panorama image according to a third embodiment of the present invention;

FIG. 9 is a detailed flow chart of acquiring a second image in a guiding method for photographing a panorama image according to an embodiment of the present invention;

FIG. 10 is a schematic view of a first image and a second image being joined in a guiding method for photographing a panorama image according to an embodiment of the present invention;

FIG. 11 is a schematic view of a panorama image in a guiding method for photographing a panorama image according to an embodiment of the present invention;

FIG. 12 is a schematic view of a plurality of joint images being joined in a guiding method for photographing a panorama image according to an embodiment of the present invention;

FIG. 13 is a detailed flow chart of calculating a motion vector in a guiding method for photographing a panorama image according to an embodiment of the present invention;

FIG. 14 is a schematic view of feature components in a second image corresponding to a first image in a guiding method for photographing a panorama image according to an embodiment of the present invention; and

FIG. 15 is a schematic view of a current position and a joint position in a guiding method for photographing a panorama image according to an embodiment of the present invention.

### DETAILED DESCRIPTION OF THE INVENTION

A guiding method for photographing a panorama image according to the present invention may be built in a memory of a digital camera device through software or a firmware program, and may be implemented by executing the built-in software or firmware program by a processor in the digital camera device.

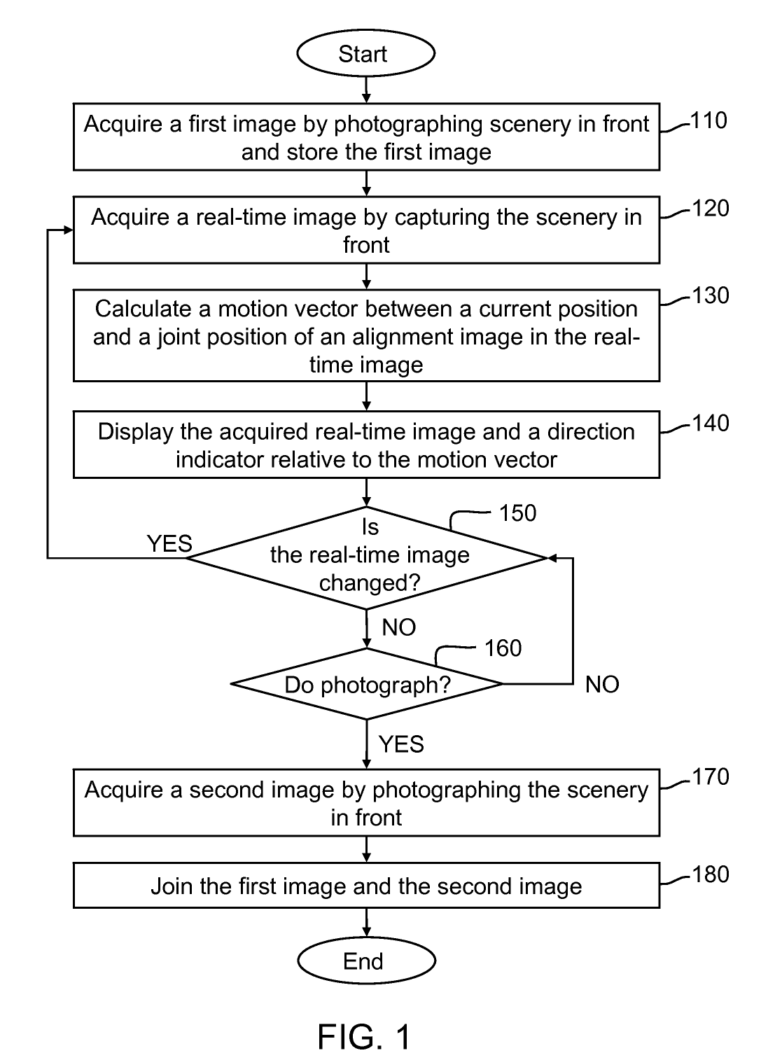

Referring to FIG. 1, in this embodiment, the guiding method for photographing a panorama image is applied in a digital camera device 10, so as to assist a user in panorama photographing. The digital camera device 10 is disposed with a camera module, a memory, a processor, and a display screen 11.

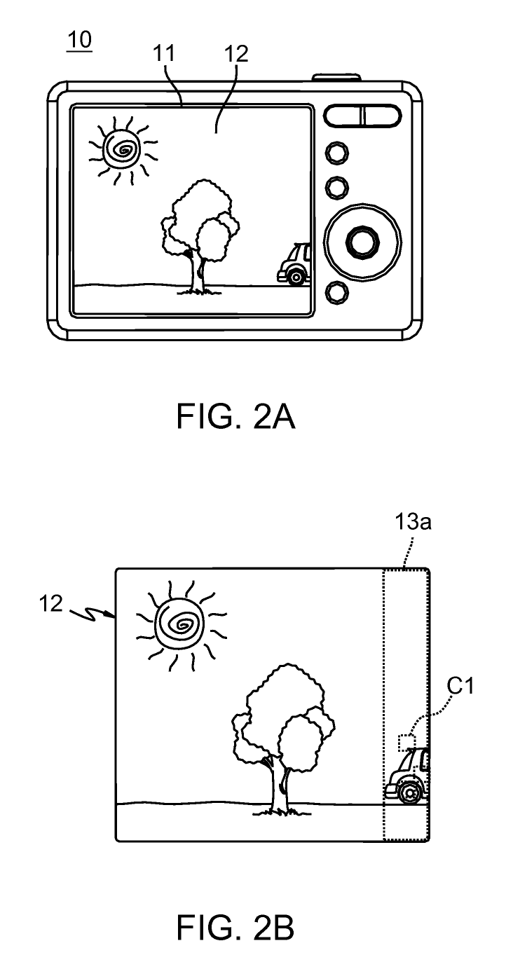

First, the digital camera device 10 acquires a first image 12 by photographing scenery in front thereof with the camera module. Referring to FIGS. 2A and 2B, the photographed first image 12 is stored in the memory (Step 110).

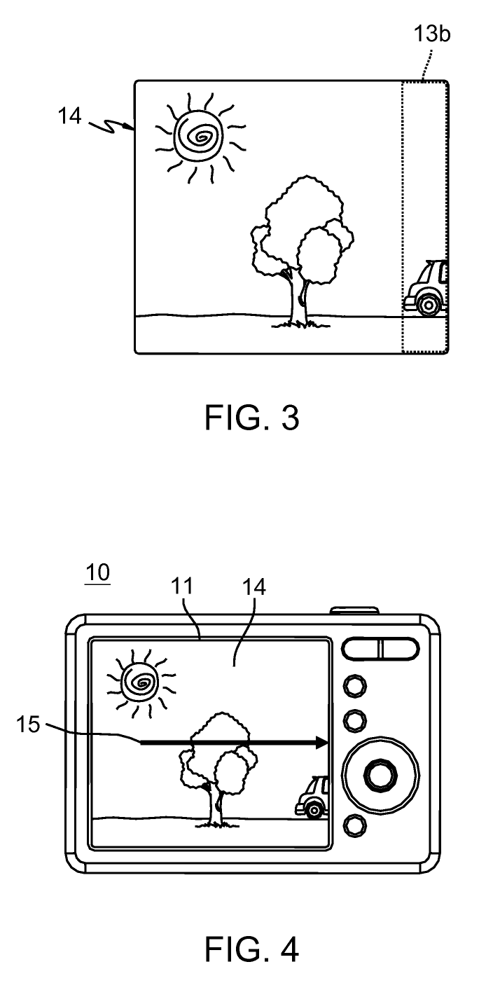

After the first image 12 is acquired, the digital camera device 10 acquires a real-time image 14 by capturing scenery in front thereof with the camera module, as shown in FIG. 3 (Step 120).

The processor analyzes the real-time image 14, so as to calculate a motion vector between a current position and a joint position of an alignment image 13b in the real-time image 14 (Step 130).

When the first image 12 is photographed and acquired, the digital camera device 10 is not moved. Thus, the scenery of the real-time image 14 on the display screen 11 is the same as the first image 12. At this time, the motion vector calculated by the processor is not zero.

Next, the processor displays the acquired real-time image 14 on the display screen 11, and displays a direction indicator 15 having an indication direction and a size corresponding to the motion vector on the display screen 11 relative to the acquired motion vector (Step 140), as shown in FIG. 4.

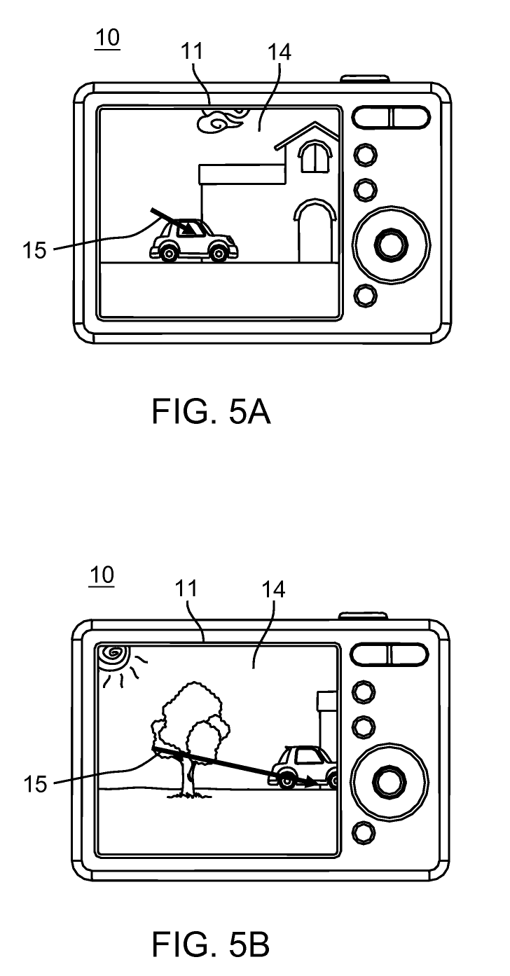

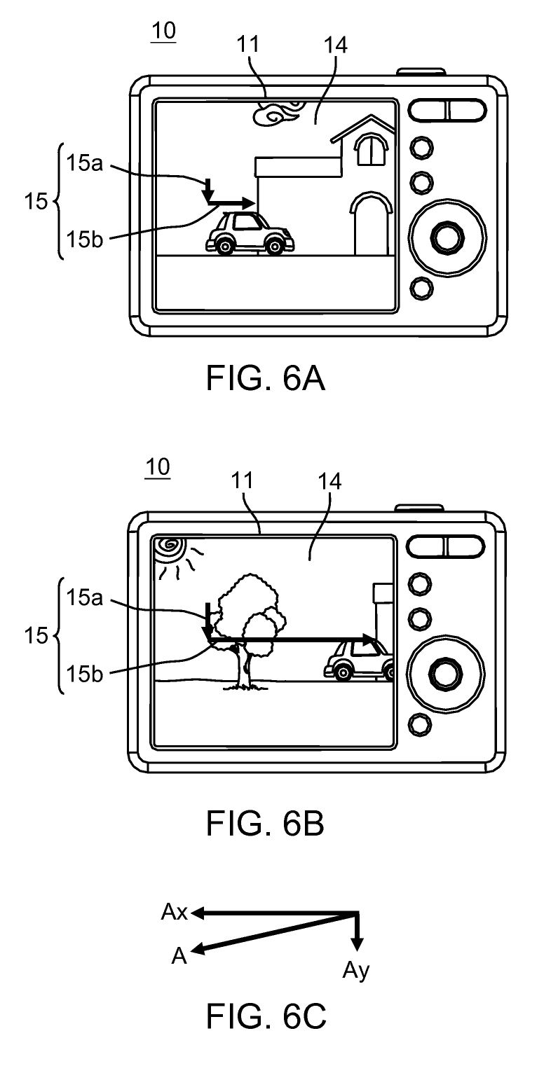

When the digital camera device 10 moves, the real-time image 14 on the display screen 11 changes accordingly. At the same time, the digital camera device 10 performs Steps 130 and 140 repeatedly, such that the direction indicator 15 displayed on the display screen 11 changes, for example, extends or contracts, with the real-time image 14, as shown in FIGS. 5A, 5B, 6A, and 6B. That is to say, the digital camera device 10 continuously detects the real-time image 14 to determine whether real-time image 14 is changed (Step 150). When the real-time image 14 is changed, the process returns to Step 120.

For example, the greater motion vector results in the longer direction indicator 15. When the alignment image 13b reaches the joint position, the calculated motion vector is zero. At this time, the length of the direction indicator 15 is zero, that is, the direction indicator 15 is not displayed.

In addition, the direction indicator 15 may also be displayed on the display screen 11 in a flickering manner, and a flickering frequency of the direction indicator 15 also corresponds to the motion vector. That is, the greater motion vector results in the smaller flickering frequency of the direction indicator 15. The closer to the joint position the alignment image 13b is, the smaller the motion vector is, and the greater the flickering frequency of the direction indicator 15 is.

Here, the processor may display a single direction indicator 15 corresponding to the motion vector on the display screen 11 according to the acquired motion vector, as shown in FIGS. 5A and 5B. The processor may also display a plurality of direction indicators 15a, 15b indicating different directions respectively corresponding to the motion vector on the display screen 11 according to the acquired motion vector. Each direction indicator 15 indicates a direction, as shown in FIGS. 6A and 6B.

In a situation of the single direction indicator 15, the processor displays a direction indicator 15 extending in the same direction as the motion vector on the display screen 11, and determines a length of the displayed direction indicator 15 according to a value of the motion vector.

In a situation of a plurality of direction indicators 15, the direction indicators 15 indicate different directions respectively, that is, extend in different directions. The processor first calculates vector components of the motion vector in the extension directions of the direction indicators 15 and then controls the display of the corresponding direction indicators 15 according to the calculated vector components. Taking two direction indicators 15a, 15b as an example, it is assumed that the two direction indicators 15a, 15b extend vertically and horizontally, respectively (subject to the display screen 11). Therefore, the processor first calculates a vertical vector component Ay and a horizontal vector component Ax of a motion vector A, as shown in FIG. 6C. Subsequently, the processor displays the direction indicator 15a having a length corresponding a value of the vector component Ay on the display screen 11 according to the vertical vector component Ay, and displays the direction indicator 15b having a length corresponding to a value of the vector component Ax on the display screen 11 according to the horizontal vector component Ax, as shown in FIG. 5B. Also, a direction of the motion vector A of the alignment image 13b from a current position to a joint position and a direction of the displayed direction indicator 15 are the same in up-down direction but opposite in left-right direction. In other words, when the motion vector A is leftward, the direction indicator 15 is rightward. When the motion vector A is rightward, the direction indicator 15 points at leftward. When the motion vector A is upward, the direction indicator 15 is upward. When the motion vector A is downward, the direction indicator 15 is downward.

Besides displaying the direction indicator 15, the digital camera device 10 may also indicate a moving direction of the digital camera device 10 with a sound suggestion, such that the alignment image 13b on the real-time image 14 moves to the joint position along with the movement of the digital camera device 10.

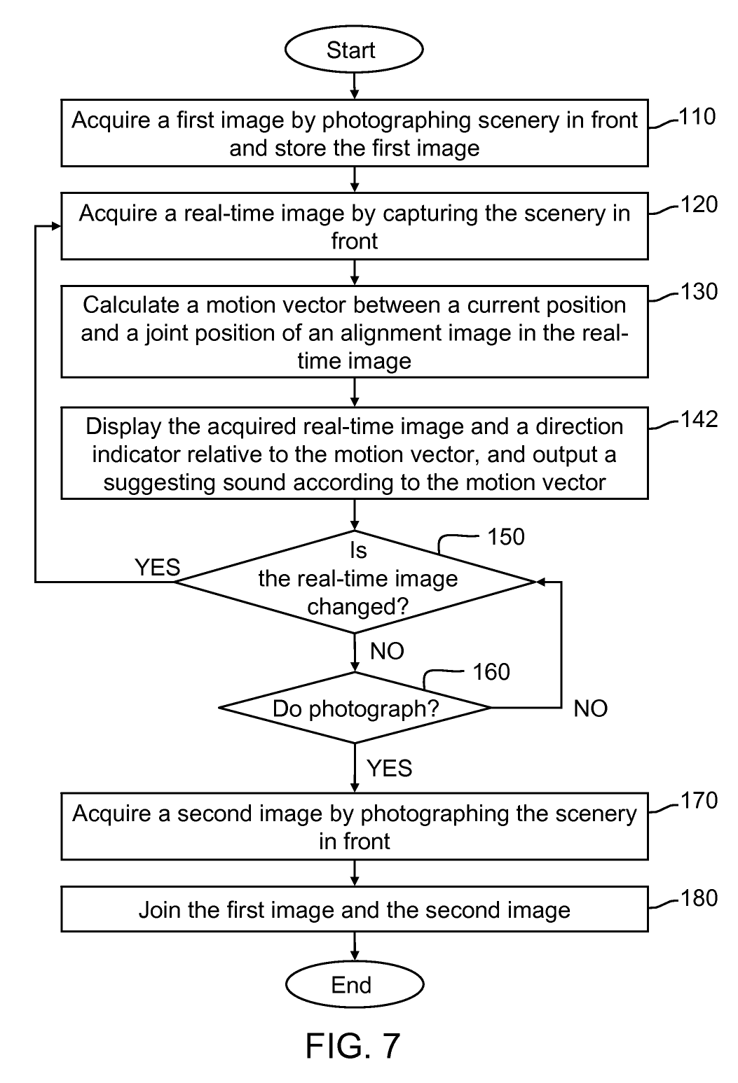

Here, the digital camera device 10 may have a speaker and output a sound suggestion corresponding to the motion vector through the speaker according to the acquired motion vector, so as to indicate a direction for a user to move the digital camera device 10, thus enabling the alignment image 13b on the real-time image 14 displayed by the digital camera device 10 to move to the joint position (Step 142), as shown in FIG. 7. The sound suggestion may be a series of or continuous single tones (for example, beeps) or a direction description words (such as upward, leftward, downward, and rightward). Also, when the alignment image 13b reaches the joint position, that is, the calculate motion vector is zero, the sound suggestion stops.

For example, the digital camera device 10 may be disposed with a buzzer. The buzzer is electrically connected to the processor and the speaker. When the processor has calculated a motion vector, besides displaying the direction indicator 15 corresponding to the motion vector on the display screen 11, the processor also sends an actuating signal according to the calculated motion vector, thus enabling the buzzer to make a series of or continuous single tones (for example, beeps) through the speaker. Also, if the buzzer makes a series of single tones, a sounding frequency of the single tone may correspond to the value of the motion vector, that is, a time interval between two adjacent single tones may correspond to the motion vector. For example, the greater the motion vector is, the smaller the sounding frequency of the single tone is, that is, the longer the time interval is. The closer to the joint position the alignment image 13b is, the smaller the motion vector is, and the greater the sounding frequency of the single tone is, that is, the shorter the time interval is. If the buzzer makes continuous single tones, the sounding volume of the single tones may correspond to the motion vector.

Moreover, the digital camera device 10 may also be a digital audio player, and the digital audio player is electrically connected to the processor, the memory, and the speaker. Direction description words of various directions are stored in the memory beforehand, and each direction description word corresponds to a direction of the motion vector. When the motion vector is calculated, the processor may read a corresponding direction description word from the memory according to the direction of the motion vector, and provide the direction description word to the digital audio player to play and output the acquired direction description word through the speaker.

Besides displaying the direction indicator 15, the digital camera device 10 may also indicate a moving direction of the digital camera device 10 with a vibration, so as to enable the alignment image 13b on the real-time image 14 to move to the joint position along with the movement of the digital camera device 10.

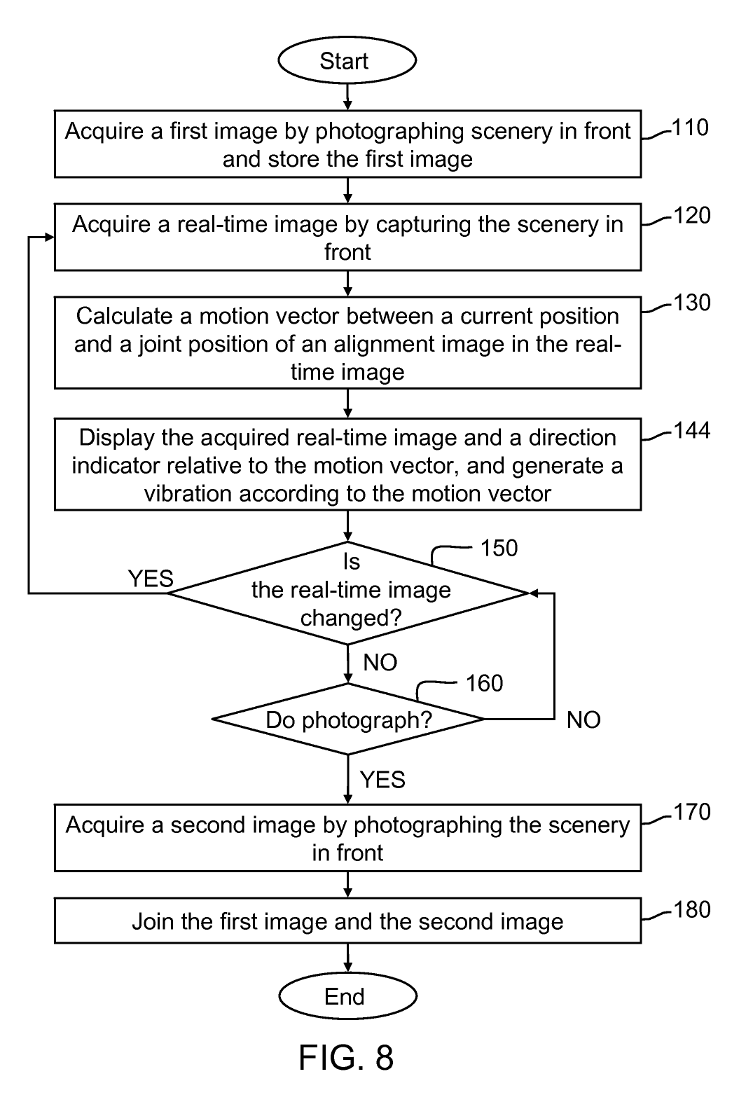

Here, the digital camera device 10 may be disposed with a vibrator. Therefore, the processor may actuate the vibrator to generate a vibration corresponding to the motion vector according to the acquired motion vector, so as to indicate the user of a direction for moving the digital camera device 10, thus enabling the alignment image 13b on the real-time image 14 displayed by the digital camera device 10 to move to the joint position (Step 144), as shown in FIG. 8. Also, when the alignment image 13b reaches the joint position, that is, the calculated motion vector is zero, the vibration stops.

A vibration frequency of the vibrator may correspond to a value of the motion vector. For example, the greater the motion vector is, the greater the vibration frequency is. The closer to the joint position the alignment image 13b is, the smaller the motion vector is, and the smaller the vibration frequency is. Moreover, the digital camera device 10 may be disposed with a plurality of vibrators. The vibrators are located at different positions of the digital camera device 10 respectively. At this time, the disposal positions of the vibrators may correspond to directions of the motion vector. Therefore, the processor may actuate the vibrator at a corresponding disposal position according to the direction of the motion vector.

Therefore, the user may determine whether to photograph or not by observing the direction indicator 15 (Step 160), such that the camera module photographs scenery in front of the digital camera device 10 (the same as the current real-time image 14) to acquire a second image 16, thereby acquiring a second image 16 having a higher joint degree with the first image 12 (Step 170). In other words, at this time, the scenery of the real-time image 14 on the display screen 11 is the same as the scenery of the photographed second image 16.

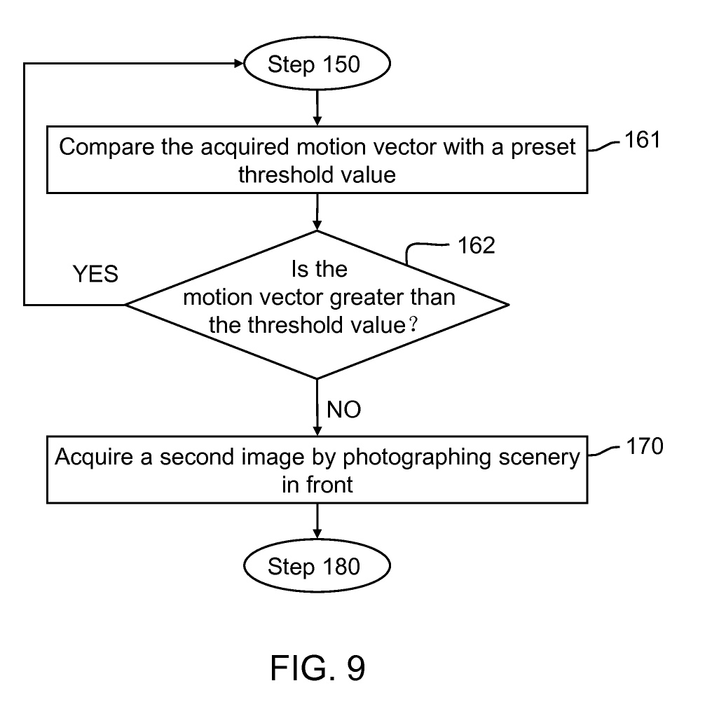

In addition, the digital camera device 10 may also determine a photographing time according to the calculated motion vector (Step 160), so as to photograph scenery in front thereof (the same as the current real-time image 14) to acquire the second image 16 automatically (Step 170). In an embodiment, referring to FIG. 9, the processor compares the acquired motion vector and a preset threshold value (Step 161). When the acquired motion vector is less than or equal to the threshold value (Step 162), the processor actuates the camera module, so as to photograph the scenery in front of the digital camera device 10 (the same as the current real-time image 14) to acquire the second image 16 (Step 170). Preferably, the threshold value may be set as zero.

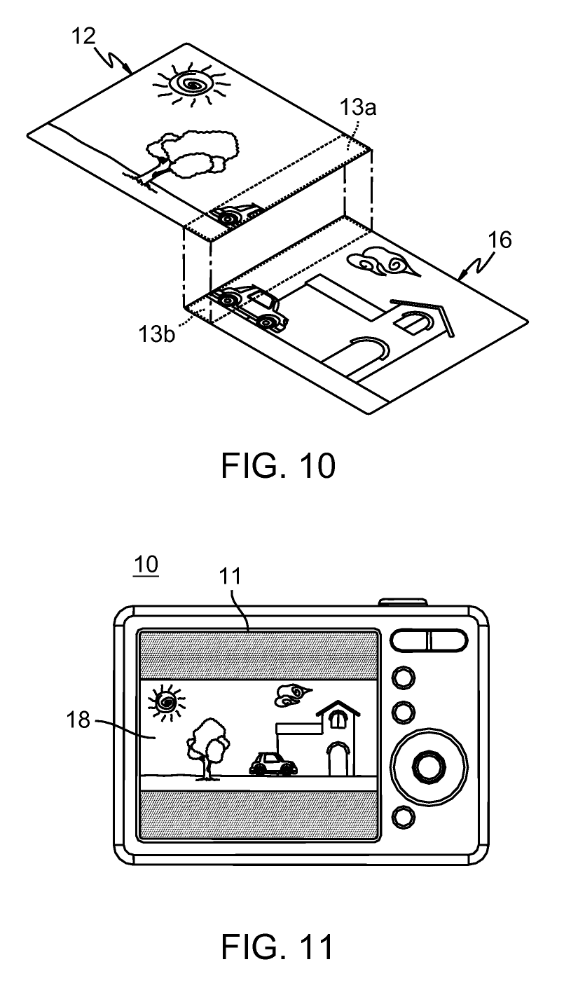

In the end, the processor of the digital camera device 10 joins the acquired images into a panorama image 18, that is, joins the first image 14 and the second image 16 to obtain the panorama image 18 (Step 180), as shown in FIGS. 10 and 11.

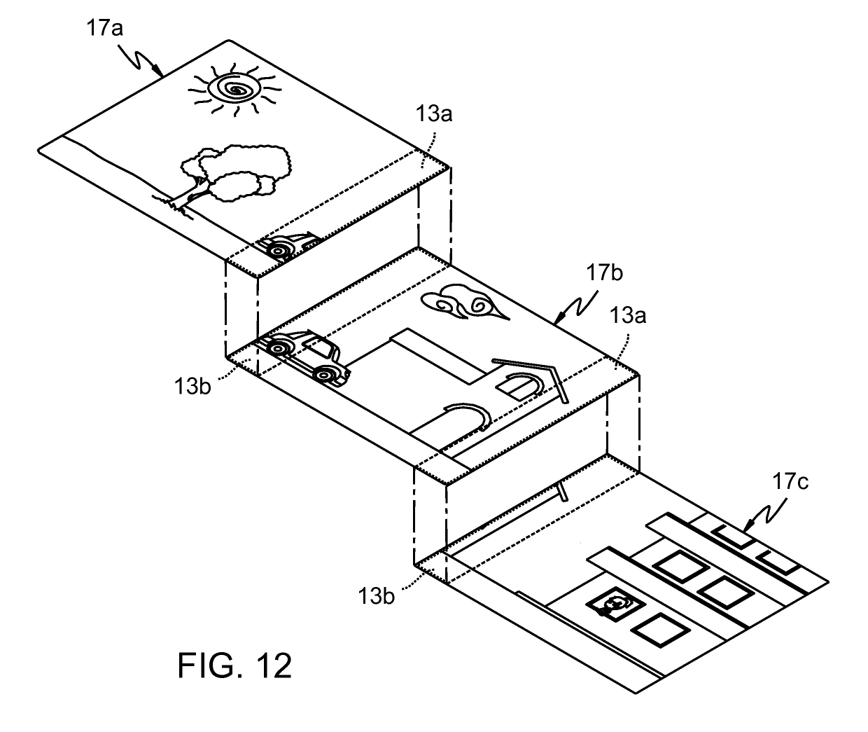

It should be noted that the present invention is not limited to joining two images. The second image 16 is set as a first image 14, and Steps 120 to 170 are performed subsequently, so as to acquire a joint image of three or four or more images (that is, the acquired first image 14 and the second image 16). Also, the acquired joint images 17a, 17b, 17c are joined through the alignment images 13a, 13b, so as to obtain a panorama image 18, as shown in FIG. 12.

The number of images to be joined may be preset in the digital camera device 10, or be selected or set by a user through an input interface provided by the digital camera device 10. Subsequently, the joint images (that is, the first image 14 and the second image 16) are then photographed according to the set number by using the guiding method for photographing a panorama image according to the present invention.

Here, the alignment images 13a, 13b are image areas where the first image 12 joins with the second image 16, as shown in FIG. 10. In other words, image blocks of the same scenery, that is, the alignment image 13a, 13b, exist in the first image 12 and the second image 16.

The alignment image 13a may be an image block of a specific proportional value at a left edge or a right edge of the first image 12. For example, a pixel size of the first image 12 is 800*600, and the preset proportional value is 20%. Therefore, a width of the alignment image 13a is calculated through a maximum cross direction width 800 of the first image 12 and the proportional value 20%. Thus, a cross direction width of the alignment image 13a is 160. Therefore, a pixel size of the alignment image 13 is 160*600.

Also, when the alignment image 13a is an image block at the right edge of the first image 12, the image block of the same scenery exists on the right edge of the second image 16, that is, the alignment image 13b. In other words, the joint position is located at a block of the same pixel size at the right edge of the real-time image 14.

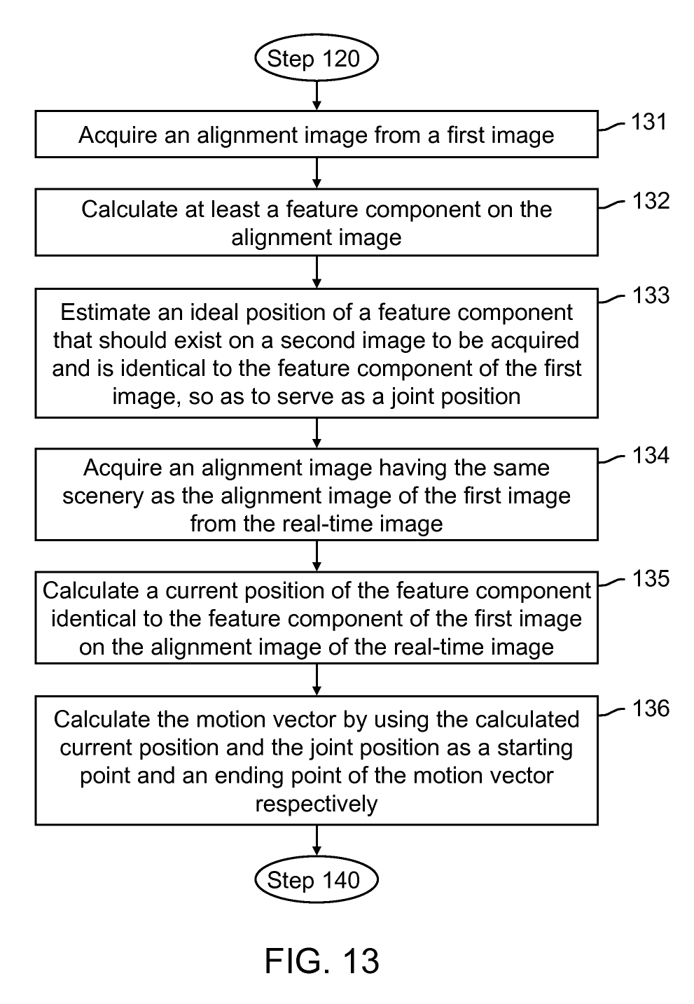

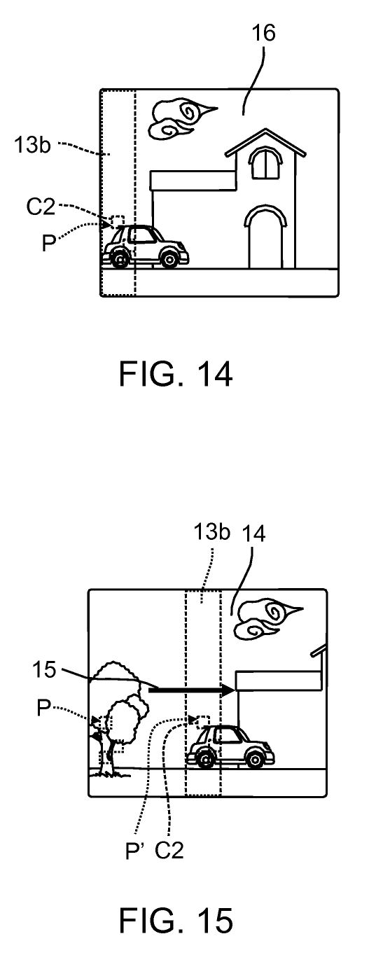

Referring to FIG. 13, the processor may calculate the motion vector through feature components C2 on the alignment image 13 (features such as an edge, a line, or an acute angle). The processor may acquire an alignment image 13a from the first image 12 by analyzing the first image 12 (Step 131), and calculate at least a feature component C1 on the alignment image 13a (Step 132), as shown in FIG. 2B. Subsequently, the processor estimates an ideal position of the feature component C2 that should exist on the second image 16 to be acquired and is identical to the feature component C1 of the first image 12, so as to serve as a joint position P (Step 133), as shown in FIG. 14. Also, the processor may acquire an alignment image 13b having the same scenery as the alignment image 13a of the first image 12 from the real-time image 14 by analyzing the real-time image 14 (Step 134), and calculate a current position P′ of the feature component C2 identical to the feature component C1 of the first image 12 on the alignment image 13b of the real-time image 14 (Step 135), as shown in FIG. 15. In the end, the processor calculates the motion vector by using the calculated current position P′ and the joint position P as a starting point and an ending point of the vector respectively (Step 136).

For example, when a user needs to photograph a panorama image, the user first switches a mode of the digital camera device 10 to a panorama photographing mode. Subsequently, the user may use the digital camera device 10 to photograph a first image 12, as shown in FIGS. 2A and 2B. When a next image is to be photographed (that is, the second image 16), the digital camera device 10 may display the real-time image 14 and the direction indicator 15 (and a sound suggestion or a vibration) by using the guiding method for photographing a panorama image according to the present invention, as shown in FIG. 4. Also, when the user moves the digital camera device 10, the real-time image 14 and the direction indicator 15 displayed on the digital camera device 10 changes with the scenery that is able to be acquired by the camera module of the digital camera device 10, as shown in FIGS. 5A, 5B, 6A and 6B. Furthermore, when the alignment image 13b of the real-time image 14 moves to or approaches the joint position, the camera module photographs the scenery in front of the digital camera device 10 to acquire the second image 16, and the processor joins the first image 12 and the second image 16 into a panorama image, as shown in FIG. 11.

In conclusion, the guiding method for photographing a panorama image according to the present invention is applied in the digital camera device. When a panorama image is photographed, after one image is photographed, the digital camera device is able to output a suggesting signal, that is, the direction indicator (and a sound suggestion or a vibration) to guide a photographing position of a next image for a user, thus simplifying the photographing of the panorama image and greatly decreasing an incidence that the user fails to photograph a panorama image.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A guiding method for photographing a panorama image, applied in a digital camera device, wherein the digital camera device has a camera module and a display screen, the guiding method comprising:
acquiring a first image by photographing scenery in front of the digital camera device with the camera module;
storing the first image;
acquiring a real-time image by capturing scenery in front of the digital camera device with the camera module after acquiring the first image;
calculating a motion vector between a current position of an alignment image in the real-time image and a joint position of the alignment image in the real-time image, wherein the alignment image is an image block in the real-time image with the same scenery as the first image, the joint position is a position where a second image to be photographed joins with the first image, and scenery of the second image is the same as the scenery of the real-time image at the time of photographing to acquire the second image;
displaying the real-time image on the display screen and displaying a direction indicator relative to the motion vector, wherein a direction of the direction indicator corresponds to a direction of the motion vector, and a length of the direction indicator corresponds to a value of the motion vector; and
detecting the real-time image continuously, wherein when it is detected that the real-time image is changed, the process returns to the step of acquiring the real-time image, so as to perform the steps of acquiring the real-time image, calculating the motion vector, and displaying the real-time image and the direction indicator again, such that the length of the direction indicator changes with the real-time image.

2. The guiding method for photographing a panorama image according to claim 1, further comprising: outputting a sound suggestion corresponding to the motion vector when displaying the real-time image and the direction indicator.

3. The guiding method for photographing a panorama image according to claim 1, further comprising: generating at least a vibration corresponding to the motion vector when displaying the real-time image and the direction indicator.

4. The guiding method for photographing a panorama image according to claim 1, wherein the direction indicator is displayed in a flickering manner when displaying the real-time image and the direction indicator.

5. The guiding method for photographing a panorama image according to claim 1, further comprising:
acquiring the second image by photographing scenery in front of the digital camera device with the camera module according to the motion vector; and
joining the first image and the second image, thereby obtaining a panorama image.

6. A guiding method for photographing a panorama image, applied in a digital camera device, wherein the digital camera device has a camera module and a display screen, comprising:
acquiring a first image by photographing scenery in front of the digital camera device with the camera module;
storing the photographed first image;
acquiring a real-time image by capturing scenery in front of the digital camera device with the camera module after acquiring the first image;
calculating a motion vector between a current position of an alignment image in the real-time image and a joint position of the alignment image in the real-time image, wherein the alignment image is an image block in the real-time image with the same scenery as the first image, the joint position is a position where a second image to be photographed joins with the first image, and scenery of the second image is the same as the scenery of the real-time image at the time of photographing to acquire the second image;
calculating a plurality of vector components of the motion vector in a plurality of different directions;
displaying the real-time image on the display screen and displaying a plurality of direction indicators relative to the plurality of calculated vector components, wherein each of the direction indicators corresponds to one of the plurality of vector components, a direction of the direction indicator correspond to a direction of the corresponding vector component, and a length of the direction indicator corresponds to a value of the corresponding vector component; and
detecting the real-time image continuously, wherein when it is detected that the real-time image is changed, the process returns to the step of acquiring the real-time image, so as to perform the steps of acquiring the real-time image, calculating the motion vector and the plurality of vector components, and displaying the real-time image and the direction indicators subsequently, such that the length of the direction indicator changes with the real-time image.

7. The guiding method for photographing a panorama image according to claim 6, further comprising: outputting a sound suggestion corresponding to the motion vector when displaying the real-time image and the plurality of direction indicators.

8. The guiding method for photographing a panorama image according to claim 6, further comprising: generating at least a vibration corresponding to the motion vector when displaying the real-time image and the plurality of direction indicators.

9. The guiding method for photographing a panorama image according to claim 6, wherein the plurality of direction indicators is displayed in a flickering manner when displaying the real-time image and the plurality of direction indicators.

10. The guiding method for photographing a panorama image according to claim 6, further comprising:
acquiring the second image by photographing the scenery in front of the digital camera device with the camera module according to the motion vector; and
joining the first image and the second image thereby obtaining a panorama image.
